(19) United States
(12) Patent Application Publication
(10) Pub. No.: US 2017/0299695 A1
(43) Pub. Date: Oct. 19, 2017

(54) METHOD FOR RADIOMETRIC CALIBRATION OF SIGNAL-OF-OPPORTUNITY BISTATIC RADARS AND REFLECTOMETERS USING INTERNAL ELECTRONIC SOURCES

(71) Applicant: U.S.A. as represented by the Administrator of the National Aeronautics and Space Administration, Washington, DC (US)

(72) Inventor: JEFFREY R. PIEPMEIER, MILLERSVILLE, MD (US)

(21) Appl. No.: 15/097,765

(22) Filed: Apr. 13, 2016

(51) Int. Cl. G01S 7/40; G01S 13/00

(52) U.S. Cl. CPC G01S 7/4021; G01S 13/003

(57) ABSTRACT

A process for radiometric calibration of signals-of-opportunity (SoOps) may include adding a noise source to a plurality of input signals of a receiver, and calibrating the plurality of inputs signals with the added noise source.

### STATEMENT OF FEDERAL RIGHTS

The invention described herein was made by employees of the United States Government and may be manufactured and used by or for the Government for Government purposes without the payment of any royalties thereon or therefore.

### FIELD

The present invention generally relates to a method for radiometric calibration of signals-of-opportunity (SoOp).

### BACKGROUND

Bi-static reflection measurement utilizing global navigation satellite service (GNSS) or other SoOPs can be used to sense ocean and terrestrial surface properties. For example, end-to-end calibration of GNSS-R has been performed using well-characterized reflection surface (e.g., water), direct path antenna, and receiver gain characterization.

However, the above-mentioned techniques do not adequately characterize fluctuations in SoOp receivers. Specifically, the time period between calibration measurements using the listed techniques is 100's to 1,000's time longer than required to adequately characterize the SoOp receiver. Thus, an alternative approach may be beneficial.

### SUMMARY

Certain embodiments of the present invention may provide solutions to the problems and needs in the art that have not yet been fully identified, appreciated, or solved by calibration methods. For example, some embodiments pertain to radiometric calibration of SoOp bi-static receivers using internal electronic sources.

In an embodiment, a process may include adding a noise source to a pair of input signals of a receiver, and calibrating the pair of inputs signals with the added noise source.

In another embodiment, a process may include adding a noise source to a plurality of input signals of a receiver, and calibrating the plurality of input signals with the added noise source.

In yet another embodiment, an apparatus includes a plurality of input signals, one for each input of a receiver. The apparatus also includes a plurality of reference switches. Each of the plurality of reference switches is configured to add a noise source from a common noise source to one of the plurality of input signals. The apparatus further includes a common noise source configured to switch between an on state and an off state to record a state of the noise source along with each input of a receiver.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a SoOp receiver, according to an embodiment of the present invention.

FIG. 2 is a flow diagram illustrating a process for radiometric calibration of SoOp reflectometers, according to an embodiment of the present invention.

### DETAILED DESCRIPTION OF THE EMBODIMENTS

Some embodiments of the present invention generally pertain to the use of on-board receiver electronics for radiometric calibration of SoOp reflectometers utilizing direct and reflected signal receiving antennas. In some embodiments, the receiver and correlator gains and offsets are calibrated using a reference switch and a common noise source.

Receivers

To account for real-world receiver characteristics of gain and noise, the gain and noise may be added to the receiver. In some embodiment, the voltage signal V_{d} of a direct path receiver is

V_{d}(t)=g_{d}(s_{d}(t)+n_{d}(t)) Equation (1)

where g_{d} is the voltage gain, and n_{d}(t) is the receiver noise. For a reflected path receiver, the voltage signal Vᵣ is

Vᵣ(t)=gᵣ(sᵣ(t) +nᵣ(t)) Equation (2)

where gᵣ is the voltage gain, and nᵣ(t) is the receiver noise. The autocorrelation K_{dd}(Γ) of the direct path voltage signal may be

K_{dd}(τ)=|g_{d}|²(Y_{dd}(τ)+(|n_{d}|²>) Equation (3)

The cross-correlation K_{rd}(Γ) of the direct and reflected paths may be

K_{rd}(τ)=gᵣg*_{d}Y_{rd}(τ)+o_{K} Equation (4)

where o_{K} is a correlator offset, which may be caused by mutual coupling between antennas. The measurement equation may be

$$\begin{matrix}{K}_{dd} ( τ ) / {\vert {g}_{d} \vert}^{2} - 〈 {\vert {n}_{d} \vert}^{2} 〉 = {Y}_{dd} ( τ ) & Equation ( 5 ) \\ {K}_{r d} ( τ ) / {g}_{r} {g}_{d}^{*} = {Y}_{r d} ( τ ) & Equation ( 6 ) \\ {\vert Γ \vert}^{2} = {\vert \frac{{K}_{r d} ( ( {R}_{r} - R ) / c ) / {g}_{r} {g}_{d}^{*}}{{K}_{dd} ( 0 ) / {\vert {g}_{d} \vert}^{2} - 〈 {\vert {n}_{d} \vert}^{2} 〉} \vert}^{2} \frac{{G}_{d}}{{G}_{r }} & Equation ( 7 )\end{matrix}$$

Because values |gd|², <|n_{d}|²>, and gᵣg_{d} may be known to measure reflectivity, the quotient is rearranged to isolate the calibration terms and the denominator yields using the following equations

$$\begin{matrix}{g}_{r} {g}_{d}^{*} ( {K}_{dd} ( 0 ) / {\vert {g}_{d} \vert}^{2} - 〈 {\vert {n}_{d} \vert}^{2} 〉 ) & Equation ( 8 ) \\ = ( {g}_{r} {g}_{d}^{*} / {\vert {g}_{d} \vert}^{2} ) ( {K}_{dd} ( 0 ) - 〈 {\vert {n}_{d} \vert}^{2} 〉 {\vert {g}_{d} \vert}^{2} ) & Equation ( 9 ) \\ = ( {g}_{r} / {g}_{d} ) ( {K}_{dd} ( 0 ) - 〈 {\vert {n}_{d} \vert}^{2} 〉 {\vert {g}_{d} \vert}^{2} ) & Equation ( 10 )\end{matrix}$$

Thus, the values of correlator gain gᵣg_{d}, the direct path receiver gain |g_{d}|², and direct path receiver noise <|n_{d}|²> may be realized. It should be appreciated that these receiver characteristics are not sufficiently stable over time to use as constant values. For this reason, on-board calibration sources and an algorithm to periodically measure the three calibration parameters may be used. In some embodiments, switches and noise sources may be used to calibrate the system.

Starting with the direct path receiver, K_{dd} (0) is the total power measurement for the antenna. K_{dd} (0) may include receiver noise, antenna noise and signal power. The receiver and antenna noise power (system noise power <|n_{d}|²> or uncalibrated noise counts <|n_{d}|²>|g_{d}|²) may be measured and subtracted. For example, in radar systems, the system noise is measured by observing noise-only echoes (i.e., echoes without a transmit pulse) or noise-only sideband channel. In SoOp, the former could be accomplished by turning off the transmitter in a cooperative system or steering the antenna towards an empty sky. The latter may be accomplished by including a receiver channel known to be source free.

In radiometer systems, the receiver noise is determined using two calibration sources and the sky noise is measured (same as the noise only side channel in radar) or modeled. The most complex case occurs when a noise-only antenna measurement cannot be made, e.g., when there are no available side channels, the transmitter is ubiquitous and persistent, and the antenna cannot be steered. Thus, the direct path receiver may need a reference switch and noise source. For the case with the noise source behind the reference switch, the measurement equations are as follows

K_{dd}(τ)=|g_{d}|²(Y_{dd}(τ)+ [symbol] |nᵣₓ|² [symbol] + [symbol] |nₐ|² [symbol] ) antenna Equation (11)

K_{dd}^{ref}(0)=|g_{d}|²( [symbol] |nᵣₓ|² [symbol] + [symbol] |n₀|² [symbol] ) reference Equation (12)

K_{dd}^{rnd}(0)=|g_{d}|²( [symbol] |nᵣₓ|² [symbol] + [symbol] |n₀|² [symbol] + [symbol] |n_{nd}|² [symbol] ) Equation (13)

When <|n₀|²> and <|n_{nd}|²> are known (i.e., calibrated), the bottom equations (12) and (13) can be solved for |g_{d}|² and <|nᵣₓ|²>. The <|nₐ|²> can be modeled or even measured when Γ is used such that Y_{dd}→0.

For the switch after the noise source, the equations are as follows

K_{dd}(τ)=|g_{d}|²(Y_{dd}(τ)+ [symbol] |nᵣₓ|² [symbol] + [symbol] |nₐ|² [symbol] ) antenna Equation (14)

K_{dd}^{ref}(0)=|g_{d}|²( [symbol] nᵣₓ|² [symbol] + [symbol] |n₀|² [symbol] ) reference Equation (15)

K_{dd}^{and}(τ)=|g_{d}|²(Y_{dd}(τ)+ [symbol] |nᵣₓ|² [symbol] + [symbol] |nₐ|² [symbol] + [symbol] |n_{nd}|² [symbol] ) ant+noise Equation (16)

Equations (14) and (16) may be used to compute the system gain <|g_{d}|> while equation (15) may be invoked to determine the receiver noise offset <|nᵣₓ|²>. Again, using Γ such that Y_{dd}→0 simplifies the process. Equation (15) may be invoked to also solve for the sky noise as well. Heretofore has been basic radiometer calibration, although complicated by the time-lag correlation receiver.

For the correlator gain, the correlator response is shown using the equation below)

K_{rd}(τ)=gᵣg*_{d}Y_{rd}(τ)+o_{K} Equation (17)

where Y_{rd}(Γ) contains the ambiguity function χ(Γ−(Rᵣ−R)|/c, 0). To reduce the notation, (Rᵣ−R)/c may be replaced with Γg, the geometrical delay. Thus,

K_{rd}(τ)=Agᵣg*_{d}χ(τ−τ_{g})+o_{K} Equation (18)

where A contains physical mechanisms operating outside the received e.g., the polarization mismatch, antenna gains, Friis transmission loss, etc. In the example of the correlator, the calibration equations not only include the source state (antenna, reference, etc.) but may also include the time lag within the correlator. When the geometric delay is much larger than the coherence time of the source, system may be designed with a compensator to track Γg. The bulk delay may be set to 0 when using the common noise diode for gain calibration. The shape of the correlator response as function of correlator lag Γ may be determined by the receiver passband response in addition to spectral properties of the source. The equations of the correlator under different instrument states are

K_{rd}(τ)=gᵣg*_{d}Aχ(τ−τ_{g})+o_{K} antenna Equation (19)

K_{rd}^{ref}(ξ)=o_{K} reference Equation (20)

K_{rd}^{rnd}(τ)=gᵣg*_{d}ρ_{nd}(τ)+o_{K} ref+noise Equation (21)

K_{rd}^{and}(τ)=gᵣg*_{d}(Aχ(τ−τ_{g})+ρ_{nd}(τ))+o_{K} ant+noise Equation (22)

where ρ_{nd}(Γ) is the cross correlation function of the noise source. In certain embodiments where ρ_{nd}(Γ) is known (e.g., determined from design parameters or lab calibration), either equation (21) or equations (19) and (22) can be used to find gᵣg_{d} the correlator gain. It should be appreciated that the reference state in equation (20) may be used to find correlator system offset 0_{K}. The antenna and noise state K^{and}_{rd} (Γ) may have two peaks, e.g., at Γ=0 and Γ_{g}. If Γ_{g} is large enough such that χ(Γ_{g})=0, then equation (22) may become equivalent to equation (21).

Calibration Algorithm

The direct signal receiver may be calibrated by computing coefficients. In some embodiment, the following derivation of the equations may be implemented by the Level 1 software. First, for the direct channel receiver, the two equations below may be inverted

K_{dd}(τ)=|g_{d}|²(Y_{dd}(τ)+ [symbol] |nᵣₓ|² [symbol] + [symbol] |nₐ|² [symbol] ) antenna Equation (23)

K_{dd}^{ref}(0)=|g_{d}|²( [symbol] |nᵣₓ|² [symbol] + [symbol] |n₀|² [symbol] ) reference Equation (24)

K_{dd}^{rnd}(0)=|g_{d}|²( [symbol] |nᵣₓ|² [symbol] + [symbol] |n₀|² [symbol] + [symbol] |n_{nd}|² [symbol] ) ref+noise Equation (25)

to solve for |g_{d}|², <|nᵣₓ|²>, and <|nₐ|²>. Equations (24) and (25) may be subtracted and then divided by <|n_{nd}|²>:

|g_{d}|²=[K_{dd}^{rnd}(0)−K_{dd}^{ref}(0)]/ [symbol] |n_{nd}|² [symbol] Equation (26)

then substitute back into the reference state (24) to find <|nᵣₓ|²>:

[symbol]

|nᵣₓ|² [symbol] =K_{dd}^{ref}(0)/|g_{d}|²− [symbol] |n₀|² [symbol] . Equation (27)

These two coefficients may be applied to equation (23) and solve for <|nₐ|²>:

[symbol]

|nₐ|² [symbol] =K_{dd}(τ)/|g_{d}|²− [symbol] |nᵣₓ|² [symbol] Equation (28)

where Γ is chosen such that Y_{dd}(Γ)→0, but K_{dd}(Γ)/=0. Typically, this condition is met with Γ=0. For the correlation gain and offset, invert

K_{rd}(τ)=gᵣg*_{d}Aχ(τ−τ_{g})+o_{K} antenna Equation (29)

K_{rd}^{and}(τ)=gᵣg*_{d}(Aχ(τ−τ_{g})+ρ_{nd}(τ))+o_{K} ant+noise Equation (30))

K_{rd}^{rnd}(τ)=gᵣg*_{d}ρ_{nd}(τ)+o_{K} ref+noise Equation (31)

The offset may be o_{K}=K^{ref}_{rd}(Γ) where Γ is chosen so χ(Γ−Γ_{g})→0. Next, the reference+noise state (31), or the arithmetic difference of the antenna+noise (30) and antenna (29) states, may be used to solve for the gain coefficient

gᵣg*_{d}=[K_{rd}^{rnd}(τ)−o_{K}]/ρ_{nd}(τ) Equation (32)

where ρ_{nd}(Γ) is known. Thus, all receiver coefficients may be fully characterized, i.e., “calibrated”.

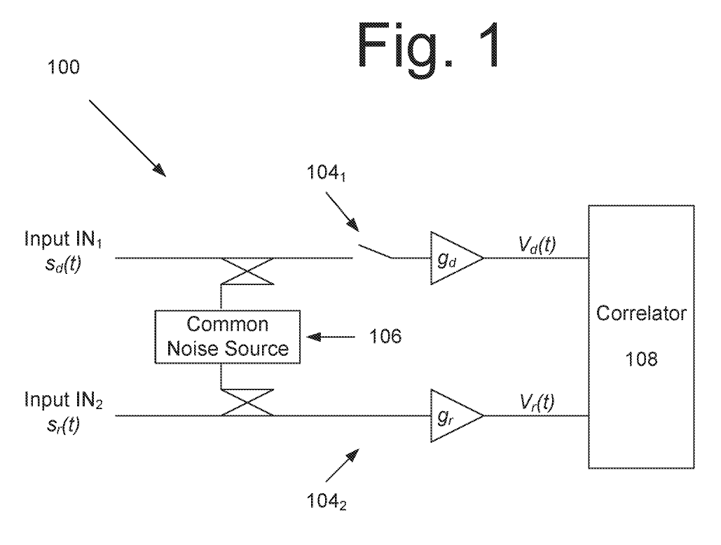

FIG. 1 is a block diagram illustrating a SoOp receiver 100, according to an embodiment of the present invention. In certain embodiments, SoOp receiver 102 may include inputs IN₁ and IN₂ for a direct path signal s_{d}(t) and a reflected path signal sᵣ(t). While SoOp receiver 100 may illustrate two inputs for signal polarization in FIG. 1, other embodiments may include more than two inputs for dual signal polarization. At each input IN₁ and IN₂, a reference switch 104₁ and 104₂ may add noise from a common noise source 106. Common noise source 106 may be turned on and off in some embodiments.

In certain embodiments, receiver 100 may have a control circuit (not shown) that cycles receiver 100 through multiple states by turning common noise source 106 on and off, and/or switching switch 104₁ and 104₂ between the antenna and a reference load. A complete set of calibration states may include (1) antenna, (2) antenna plus noise, (3) switch reference, and (4) switch reference plus noise.

In some embodiments, switching rate and duty cycle should be selected to allow tracking of the expected gain and offset variations of receiver 100. Variations may be driven by 1/f noise of electronics, thermal variations, and aging effects. In certain embodiments, switching may occur at 1 cycle per second or faster. The instrument data system (not shown) may capture the outputs of correlator and tag the data with time stamps and calibration state (e.g., reference, reference plus noise, etc.).

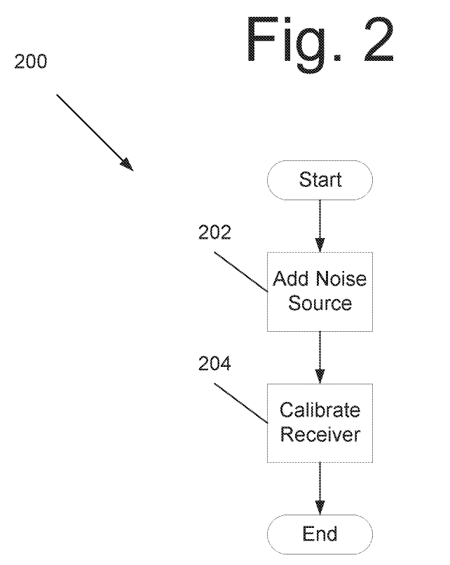

FIG. 2 is a flow diagram illustrating a process 200 for radiometric calibration of SoOp reflectometers, according to an embodiment of the present invention. In some embodiments, process 200 may begin at 202 with adding a noise source to a pair of input signals of a receiver. In one or more alternative embodiments, multiple input signals may be utilized, e.g., 2 input signals, 4 input signals, or any number of input signals that would be readily appreciated by a person of ordinary skill in the art. In some embodiments, a noise source may be added to a receiver using coupling circuits or switches. The noise source in some embodiments may be a noise diode or a signal generator. In some embodiments, the output power of the noise source may be split and directed to each receiver input.

At 204, the pair of inputs signals with the added noise source may be calibrated. In some embodiments, the noise source may be turned on and off periodically. In these embodiments, the state of the noise source may be recorded along with receiver output. The recorded data may be used to compute the calibration coefficients of the receiver. The coefficients may be used to correct the receiver output and compute radiometric quantities.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A process, comprising:
adding a noise source to a pair of input signals of a receiver; and
calibrating the pair of inputs signals with the added noise source.

2. The process of claim 1, wherein the noise source is added using coupling circuits or switches.

3. The process of claim 1, wherein the noise source comprises a noise diode or a signal generator.

4. The process of claim 1, wherein the adding of the noise source further comprises splitting the noise source and directing the noise source to each input of the receiver.

5. The process of claim 1, wherein the calibrating the pair of input signals with the added noise source further comprises periodically switching the noise source from an on state to an off state.

6. The process of claim 1, wherein the calibrating the pair of input signals with the added noise source further comprises recording a state of the noise source along with each input of the receiver.

7. The process of claim 6, wherein the calibrating the pair of input signals with the added noise source further comprises using the recorded data to compute a calibration coefficient for each input of the receiver.

8. The process of claim 7, wherein the calibrating the pair of input signals with the added noise source further comprises correcting an output of the receiver using the calibration coefficient for each input of the receiver.

9. The process of claim 7, wherein the calibrating the pair of input signals with the added noise source further comprises computing radiometric quantities of the receiver using the calibration coefficient for each input of the receiver.

10. A process, comprising:
adding a noise source to a plurality of input signals of a receiver; and
calibrating the plurality of input signals with the added noise source.

11. The process of claim 10, wherein the noise source is added using coupling circuits or switches.

12. The process of claim 10, wherein the noise source comprises a noise diode or a signal generator.

13. The process of claim 10, wherein the adding of the noise source further comprises splitting the noise source and directing the noise source to each input of the receiver.

14. The process of claim 10, wherein the calibrating the plurality of input signals with the added noise source further comprises periodically switching the noise source from an on state to an off state.

15. The process of claim 10, wherein the calibrating the plurality of input signals with the added noise source further comprises recording a state of the noise source along with each input of the receiver.

16. The process of claim 15, wherein the calibrating the plurality of input signals with the added noise source further comprises using the recorded data to compute a calibration coefficient for each input of the receiver.

17. The process of claim 16, wherein the calibrating the plurality of input signals with the added noise source further comprises correcting an output of the receiver using the calibration coefficient for each input of the receiver.

18. The process of claim 16, wherein the calibrating the plurality of input signals with the added noise source further comprises computing radiometric quantities of the receiver using the calibration coefficient for each input of the receiver.

19. An apparatus, comprising:
a plurality of input signals, one for each input of a receiver;
a plurality of reference switches, each of the plurality of reference switches is configured to add a noise source from a common noise source to one of the plurality of input signals; and
a common noise source configured to switch between an on state and an off state to record a state of the noise source along with each input of a receiver.

20. The apparatus of claim 19, wherein the recorded data is used to compute a calibration coefficient for each input of the receiver, and the calibration coefficient is used to correct an output of the receiver.
